(19) United States
(12) Patent Application Publication
(10) Pub. No.: US 2022/0163757 A1
(43) Pub. Date: May 26, 2022

(54) QUICK-RELEASE NIGHT-VISION DEVICE INTERFACE

(71) Applicant: Zhike WANG, Hengyang City (CN)

(72) Inventor: Zhike WANG, Hengyang City (CN)

(21) Appl. No.: 17/534,477

(22) Filed: Nov. 24, 2021

(30) Foreign Application Priority Data
Nov. 25, 2020 (CN) 202022757151.5

(51) Int. Cl. G02B 7/14; G02B 7/02

(52) U.S. Cl. CPC G02B 7/14; G02B 7/021

(57) ABSTRACT

Disclosed is a quick-release night-vision device interface, which relates to the field of night-vision devices, and which includes a night-vision device body and a connection device to which a sight is mounted. The connection device is snap-fitted on a connection ring of the night-vision device body, and the connection ring is provided with a fixing mechanism for fixing the connection device. A snap boss is fixedly mounted on an outer side of the connection ring, and an inner side wall of the connection device is provided with a snap groove snap-fitted with the snap boss of the connection ring. An inner side of the connection ring is provided with a snap groove, and an outer side wall of the sight is provided with a snap boss snap-fitted with the snap groove on the inner side of the connection ring. In the present invention, the connection device is connected to the night-vision device body in a snap-fitting manner, and the connection device is small in size and is stable and convenient, so that the use of threads or other forms of engagement is avoided, and accurate positioning, and stable, reliable and quick mounting and dismounting are facilitated.

### TECHNICAL FIELD

The present invention relates to the technical field of night-vision devices, and in particular to a quick-release night-vision device interface.

### BACKGROUND

A night-vision device is an infrared night-sighting device with a solid-state image sensor or an image intensifier as a core component. During operation, the night vision device uses an infrared light source to illuminate targets or use light rays that are reflected by the targets in low light situations and pass through the solid-state image sensor or the image intensifier to enhance a visible image that can be perceived by human eyes on a display screen, so as to assist in observing and aiming at the targets. The existing connection interface between the night-vision device and an optical sight is inconvenient for mounting and dismounting, is large in size, takes up more space, and has a poor stability. Moreover, the existing interfaces use threaded connections with male and female threads, for example, a housing of the night-vision device has a male (female) thread while a connection device has a female (male) thread, and the night-vision device is screwed on the connection device.

As the night-vision device is screwed on the connection device by means of the male and female threads, which may require many turns, it is not convenient for accurate positioning, quick release and replacement.

### SUMMARY

An objective of the present invention is to provide a quick-release night-vision device interface, in order to solve the problem of inconvenient mounting and dismounting of the night-vision device and the optical sight discussed in the background art.

To solve the above technical problem, in a technical scheme of the present invention, there is provided a quick-release night-vision device interface, which comprises a night-vision device body and a connection device connected to a sight. The connection device is snap-fitted on a connection ring of the night-vision device body, and the connection ring is provided with a fixing mechanism for fixing the connection device.

Optionally, the connection device is a sleeve.

Optionally, a snap boss is fixedly mounted on an outer side of the connection ring, and an inner side wall of the connection device is provided with, a snap groove snap-fitted with the snap boss.

Optionally, an O-ring is arranged in a contact area between the night-vision device body and the connection device.

Optionally, the connection device is arranged at a tail of the sight.

Optionally, a snap boss is fixedly arranged on an outer side of the sight, and an inner side wall of the connection ring is provided with a snap groove snap-fitted with the snap boss.

Optionally, a snap boss is fixedly mounted on an outer side of the optical sight, and an inner side wall of the connection ring is provided with a snap groove snap-fitted with the snap boss.

Optionally, the fixing mechanism comprises a spring mounted on a side wall of the connection ring, a slider sliding on an outer side of the connection ring, and a locking key, where one end of the spring is fixed to an inner cavity of the side wall of the connection ring and the other end is fixed to the slider; the locking key is located on the outer side of the connection ring, and the locking key is fixedly connected to one end of the slider away from the spring; and a side wall at one end of the connection device is provided with a locking hole matching the locking key.

Optionally, the fixing mechanism comprises a spring mounted on a side wall of the connection ring, a slider sliding on the outer side of the connection ring, and a locking key, wherein one end of the spring is fixed to an inner cavity of the connection ring and the other end is fixed to the slider; the slider is located at the side wall of the connection ring; the locking key is located on an inner side of the connection, ring, and the locking key is fixedly connected to one end of the slider away from the spring; and a side wall at one end of the snap boss is provided with a locking hole matching the locking key.

Compared with the related art, the present invention has the following beneficial effects:

In the present invention, the connection device is connected to the night-vision device body in a snap-fitting manner, and the connection device interface has a small size, good stability and high repeatability and accuracy in positioning and is convenient for quick release.

### BRIEF DESCRIPTION OF DRAWINGS

FIG. 1 is a schematic diagram of the structure of Embodiment One of the present invention;

FIG. 2 is an enlarged view at part Ain FIG. 1 of the present invention;

FIG. 3 is a schematic diagram of the structure of Embodiment Two of the present invention; and

FIG. 4 is an enlarged view at part B in FIG. 2 of the present invention.

In the accompanying drawings: 1. Connection device; 2. Locking hole; 3. Snap groove; 4. O-ring; 6. Snap boss; 7. Fixing mechanism; 71. Locking key; 72. Slider; 73. Spring; 8. Night-vision device body; 9. Optical sight.

### DETAILED DESCRIPTION

For ease of use, an embodiment of the present invention provides a quick-release night-vision device interface. The technical schemes in the embodiments of the present invention are clearly and completely described in the following with reference to the drawings in the embodiments of the present invention. It is obvious that the described embodiments are only some of the embodiments of the present invention and are not all the embodiments. All other embodiments obtained by those of ordinary skill in the art based on the embodiments of the present invention without inventive effort are within the scope of the present invention.

### Embodiment One

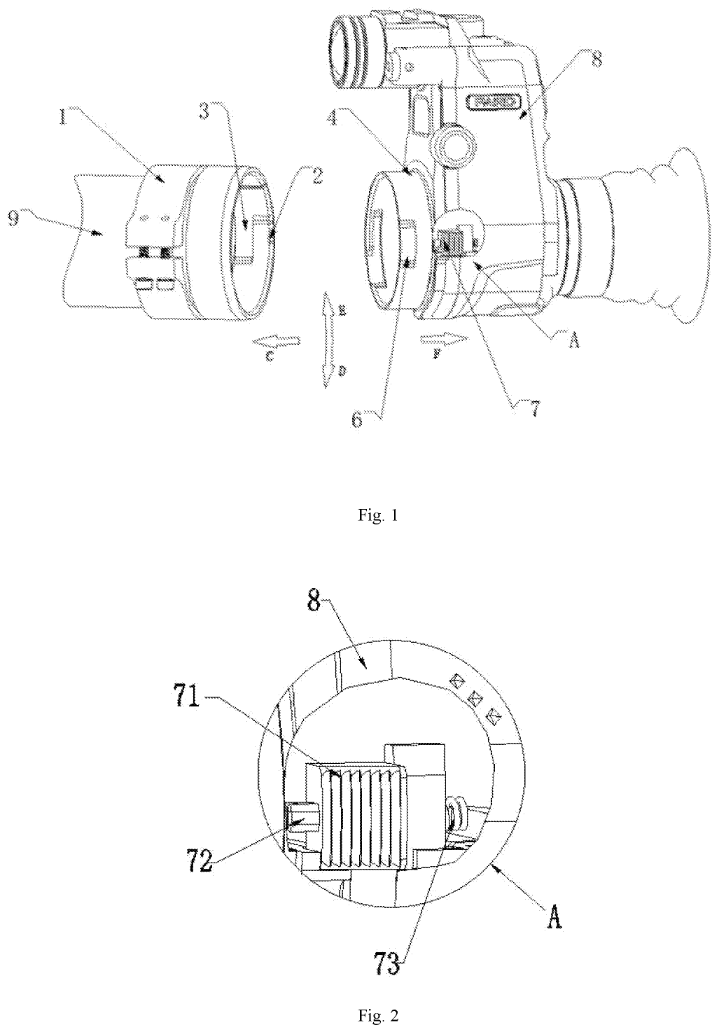

Referring to FIGS. 1 and 2, this embodiment provides a quick-release night-vision device interface including a night-vision device body 8 and a connection device 1 to which a sight is mounted. The connection device 1 is snap-fitted on a connection ring of the night-vision device body 8, and the connection ring is provided with a fixing mechanism 7 for fixing the connection device 1. By snap-fitting the connection ring 1 on the night-vision device body 8, the use of threads is avoided, so that the connection device 1 is convenient for mounting and dismounting.

The connection device is a cylindrical sleeve structure, and may alternatively be a columnar structure with other shapes.

Moreover, the object to which the connection device is applied may be the connection device to which, the sight 9 is mounted or a sight with, such a connection device. Optionally, it is a sleeve to which the sight 9 is mounted or a sight with a sleeve. The sight is optionally an optical sight.

In order to make the mounting/dismounting of the night-vision device body 8 to/from the optical sight more convenient, as shown in FIG. 1, a snap boss 6 is fixedly mounted on an outer side of the connection ring, and an inner side wall of the sleeve is provided with a snap groove 3 configured to be snap-fitted with the snap boss 6. Optionally, the snap groove 3 is an L-shaped snap groove. After the sleeve is fixed to the tail of the optical sight, the sleeve can be mounted only by pushing the snap boss 6 into the snap groove 3 (in the direction indicated by C in FIG. 1) and then rotating the night-vision device body 8 (in the direction indicated by E in FIG. 1) such that the snap boss 6 is located on the innermost side of the snap groove 3 and a spring 73 in the fixing mechanism 7 pushes a locking key 71 into a locking hole. Reverse rotation (in the direction indicated by D in FIG. 1) enables the removal of the night-vision device body 8, so that the mounting and dismounting are both facilitated.

In order to avoid the weak snap-fitting between the sleeve and the connection ring, the fixing mechanism 7 includes a spring 73 mounted on a side wall of the connection ring, a slider 72 sliding on the outer side of the connection ring, and a locking key 71. The connection ring is provided with a mounting groove for having the slider 72 mounted therein. One end of the spring 73 is fixed to an inner cavity of the side wall of the connection ring and the other end is fixed to the slider 72. The spring 73 provides an elastic force to the slider 72, which can reset the slider 72. The locking key 71 is located on the outer side of the connection ring, and the locking key 71 is fixedly connected to one end of the slider 72 away from the spring. A side wall at one end of the sleeve is provided with a locking hole 2 matching the locking key 71. The locking hole 2 cooperates with the locking key to fix the sleeve, thereby preventing the sleeve from rotating inside the connection ring, avoiding shaking, and making the snap-fitting between the sleeve and the connection ring firmer.

When the night-vision device body 8 needs to be removed, the night-vision device body 8 can be rotated only by pressing the slider 7 (in the direction indicated by F in FIG. 1), so that the night-vision device body 8 can be separated from the sleeve.

An O-ring is arranged in a contact area between the night-vision device body 8 and the sleeve. The O-ring 4 plays the role of tight connection, which can ensure the coaxiality and smooth hand feeling between the night-vision device body 8 and the sleeve. Moreover, the O-ring 4 also has the effects of shock absorption and offsetting, the machining error of the docked components.

As shown in FIG. 1, during quick assembly, after the sleeve is fastened to the optical sight, the night-vision device is fitted into the sleeve in the direction indicated by C until abutting against the O-ring, and the night-vision device is then rotated in the direction indicated by E, such that a slope on the snap boss of the target device will gradually press down the locking key, and when the night-vision device is continuously rotated to a limit position, the locking key will be pushed into the snap groove under the action of the elastic force from the spring, thereby completing the locking action.

During quick disassembly, the locking key is pushed to the right to leave the snap groove, and the night-vision device can be removed by rotating same to a specified angle in the direction indicated by D, thereby completing the disassembling action.

### Embodiment Two

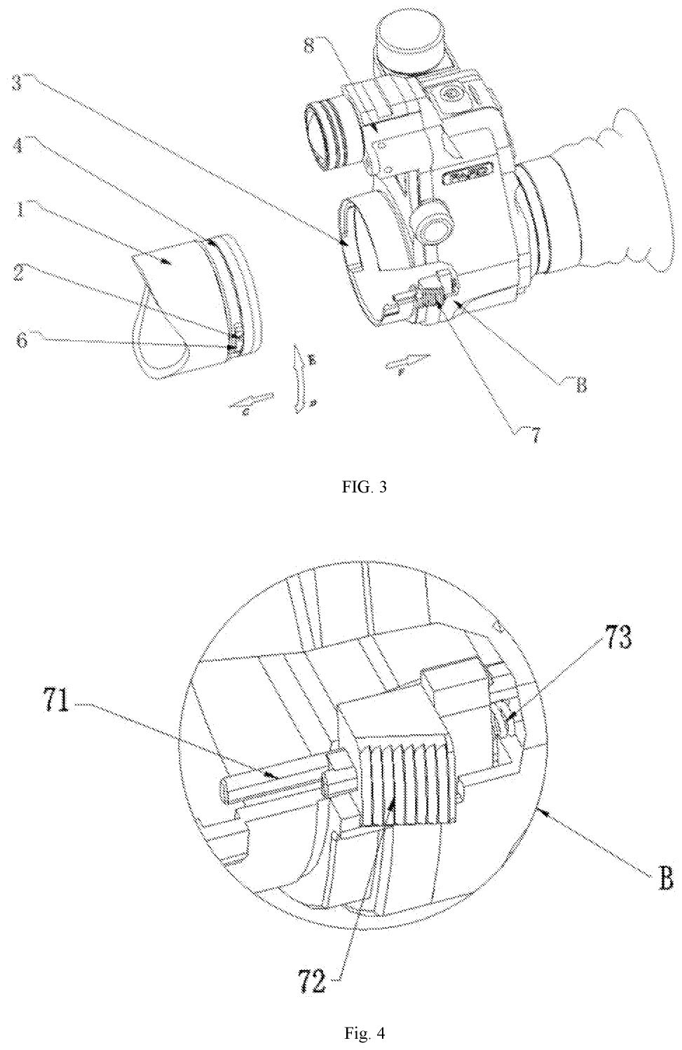

Referring to FIGS. 3 and 4, the differences from Embodiment One are as follows:

The connection device may alternatively be arranged at a tail of the sight. For example, a snap boss 6 is fixedly mounted on the outer side of the tail of the sight, and an inner side wall of the connection ring is provided with a snap groove 3 snap-fitted with the snap boss 6, so that the sight is snap-fitted with the inner side of the connection ring. The snap boss 6 is snap-fitted into the snap groove 3 (in the direction indicated by C in FIG. 3), and the night-vision device body 8 is then rotated (in the direction indicated by E in FIG. 2) such that the snap boss 6 is located on the innermost side of the snap groove 3, so that the night-vision device can be mounted on the sight.

An O-ring is arranged in a contact area between the night-vision device body 8 and the tail of the sight. The O-ring 4 plays the role of tight connection, which can ensure the coaxiality and smooth hand feeling between the night-vision device body 8 and the optical sight. Moreover, the O-ring 4 also has the effects of shock absorption and offsetting the machining error of the docked components.

The snap groove 3 is also of an L-shaped structure.

The fixing mechanism 7 comprises a spring 73 mounted on a side wall of the connection ring, a slider 72 sliding on the outer side of the connection ring, and a locking key 71. One end of the spring 73 is fixed to an inner cavity of the connection ring and the other end is fixed to the slider 72. The slider 72 is, located at the side wall of the connection ring. The locking key 71 is located on an inner side of the connection ring, and the locking key 71 is fixedly connected to one end of the slider 72 away from the spring. A side wall at one end of the snap boss 6 is provided with a locking hole 2 matching the locking key 71. The slider 72 may also reciprocate with the locking key 71 to achieve engagement with and disengagement from the locking hole.

Of course, the slider 72 may be of other structures, such as a structure similar to a reciprocating switch of a flashlight.

Although the embodiments of the present invention have been shown and described, it can be understood by those of ordinary skill in the art that Various changes, modifications, substitutions, and variations may be made to these embodiments without departing from the principles and concepts of the present invention, and the scope of the present invention is defined by the appended claims and their equivalents.

1. A quick-release night-vision device interface, comprising: a night-vision device body (8), a connection device (1) connected to a sight, a first lens group arranged inside the night-vision device body (8), and a second lens group arranged inside the sight, the first lens group and the second lens group being arranged on the same optical path, wherein the connection device (1) is snap-fitted on a connection ring of the night-vision device body (8), and the connection ring is provided with a fixing mechanism (7) for limiting and locking the connection device.

2. The quick-release night-vision device interface of claim 1, wherein the connection device (1) is a sleeve, and the connection device (1) is snap-fitted on a periphery of the connecting ring.

3. The quick-release night-vision device interface of claim 2, wherein a snap boss (6) is fixedly arranged on an outer side of the connection ring, and an inner side wall of the sleeve is provided with a snap groove (3) snap-fitted with the snap boss (6).

4. The quick-release night-vision device interface of claim 3, wherein an O-ring (4) is arranged in a contact area between the night-vision device body (8) and the connection device (1), and the O-ring (4) supports the connection device (1) in a radial direction.

5. The quick-release night-vision device interface of claim 1, wherein the connection device (1) is arranged at a tail of the sight, and the connection device (1) is snap-fitted in an inner cavity of the connecting ring.

6. The quick-release night-vision device interface of claim 5, wherein a snap boss (6) is fixedly arranged on an outer side of the sight, and an inner side wall of the connection ring is provided with a snap groove (3) snap-fitted with the snap boss (6).

7. The quick-release night-vision device interface of claim 6, wherein an O-ring (4) is arranged in a contact area between the night-vision device body (8) and the sight, and the O-ring (4) supports the connection device (1) in a radial direction.

8. The quick-release night-vision device interface of claim 2, wherein the fixing mechanism (7) comprises a spring (73) mounted on a side wall of the connection ring, a slider (72) sliding on an outer side of the connection ring, and a locking key (71), wherein the spring (73) has one end in contact with an inner cavity of the side wall of the connection ring and the other end in contact with the slider (72); the locking key (71) is located on the outer side of the connection ring, and the locking key (71) is fixedly connected to one end of the slider (72) away from the spring; and a side wall at one end of the connection device (1) is provided with a locking hole (2) matching the locking key (71).

9. The quick-release night-vision device interface of claim 3, wherein the fixing mechanism (7) comprises a spring (73) mounted on a side wall of the connection ring, a slider (72) sliding on the outer side of the connection ring, and a locking key (71), wherein the spring (73) has one end fixed to an inner cavity of the connection, ring and the other end fixed to the slider (72); the slider (72) is located at the side wall of the connection ring; the locking key (71) is located on an inner side of the connection ring, and the locking key (71) is fixedly connected to one end of the slider (72) away from the spring; and a side wall at one end of the snap boss (6) is provided with a locking hole matching the locking key (71).

10. The quick-release night-vision device interface of claim 1, wherein the sight is an optical sight.
